(19) United States
(12) Patent Application Publication
(10) Pub. No.: US 2026/0263311 A1
(43) Pub. Date: Sep. 10, 2026

(54) MASSAGE DEVICE

(71) Applicant: FUJI Medical Instruments MFG. CO.,LTD., Osaka (JP)

(72) Inventors: Kentaro ODE, Osaka (JP); Akira KAWASAKI, Osaka (JP); Junpei YOKOYAMA, Osaka (JP)

(21) Appl. No.: 19/545,509

(22) Filed: Feb. 20, 2026

(30) Foreign Application Priority Data
Mar. 5, 2025 (JP) 2025-034948

(51) Int. Cl. A61H 9/00; A61H 15/00

(52) U.S. Cl. CPC A61H 9/0078; A61H 15/0078; A61H 2015/0021; A61H 2201/0149; A61H 2201/5007; A61H 2201/5064; A61H 2205/06; A61H 2205/081

(57) ABSTRACT

A massage device includes a treatment member configured to treat a forearm of a person to be treated, a detection portion configured to detect the forearm, and a drive portion configured to move the treatment member in a longitudinal direction of the forearm based on detection information from the detection portion.

### CROSS-REFERENCE TO RELATED APPLICATIONS

This application claims priority to Japanese Patent Application No. 2025-034948 filed on March 5, 2025 with Japan Patent Office. The entire disclosure of Japanese Patent Application No. 2025-034948 is hereby incorporated herein by reference.

### BACKGROUND

### Field of the Invention

The present invention relates to a massage device including an arm treatment portion that treats an arm of a person to be treated.

### Background Information

Conventionally, a massage machine capable of treating a body of a person to be treated has been known (see JP 2005-13463 A). The massage machine includes a seat on which a person to be treated is seated, a base that supports the seat, and a backrest connected to a back side in a manner capable of reclining via a pivot, and armrests rising on both sides of the seat. On each armrest, an arm placing portion (arm treatment portion) including a tubular arm receiver having an opening on the upper side is attached, and arm airbags (treatment members) are disposed inside each of the arm receivers in conformity with the arm receivers.

The massage machine treats the arm of a person to be treated with inflation and deflation of the arm airbags.

### SUMMARY

In the massage machine described above, the arm placing portions are fixed to the base, and the positions of the arm placing portions in the front-back direction cannot be changed.

Therefore, the positions of the arms on the arm placing portions can be deviated (separated) from the positions suitable for treatment according to the height of the person to be treated, a change in posture of the person to be treated due to reclining of the backrest, and the like. In this case, the massage machine cannot treat the arms of the person to be treated at the correct positions, and when the person to be treated wants to place his/her arms at suitable positions, the person to be treated has to adjust the positions of the arms in the arm placing portions by himself/herself.

One object of the present disclosure is to provide a massage device capable of adjusting the positions of treatment members with respect to arms.

A massage device according to the present disclosure includes a treatment member configured to treat a forearm of a person to be treated, a detection portion configured to detect the forearm, and a drive portion configured to move the treatment member in a longitudinal direction of the forearm based on detection information from the detection portion.

According to the configuration, the detection portion detects the forearm and the treatment member moves, whereby the position of the treatment member with respect to the forearm can be adjusted.

The massage device can include an arm treatment portion including the treatment member and the detection portion, the arm treatment portion being movable in the longitudinal direction of the forearm based on the detection information from the detection portion.

According to the configuration, the treatment member and the detection portion can move together with the arm treatment portion while maintaining the relative positions of the treatment member and the detection portion. As a result, whether the forearm is at a suitable position with respect to the treatment member can be accurately detected even when the treatment member and the detection portion move in the front-back direction to align the forearm with respect to the treatment member.

In the massage device, the detection portion can include a first sensor disposed at the arm treatment portion and a second sensor disposed at the arm treatment portion and located behind the first sensor in the longitudinal direction of the forearm.

According to the configuration, it is possible to detect whether the forearm is in the arm treatment portion and the position of the forearm in the arm treatment portion.

The massage device can include a backrest tiltable with respect to an installation surface on which the massage device is configured to be installed, the treatment member being movable independently of tilting of the backrest.

According to the configuration, it is possible to adjust the position of the treatment member with respect to the forearm regardless of the tilting of the backrest.

In the massage device, the drive portion can move the treatment member based on detection information from both the first sensor and the second sensor.

According to the configuration, based on the detection information from the first sensor and the second sensor spaced apart in the longitudinal direction of the forearm, the arm treatment portion can accurately move to a position suitable for treatment with respect to the forearm in the longitudinal direction of the forearm.

In the massage device, the second sensor can be configured to detect presence or absence of the forearm, and the first sensor can be configured to detect a position of a hand.

According to the configuration, the first sensor and the second sensor detect different portions of the forearm, so that it is more accurately determined that the forearm is disposed at a suitable position, and treatment by the treatment member is more effective.

In the massage device, the drive portion can move the treatment member forward in the longitudinal direction of the forearm when only the first sensor detects the forearm, or move the treatment member backward in the longitudinal direction of the forearm when only the second sensor detects the forearm.

According to the configuration, even when the treatment member moves due to detection of the forearm by one sensor (the first sensor or the second sensor) of the two sensors (the first sensor and the second sensor), the drive portion can accurately move the treatment member to a position suitable for treatment with respect to the forearm.

In the massage device, the drive portion can stop the movement of the treatment member when both of the first sensor and the second sensor detect the forearm.

According to the configuration, it is possible to prevent movement of the treatment member when the forearm is at a position suitable for treatment.

In the massage device, the drive portion can stop the movement of the treatment member when detection information from the first sensor and detection information from the second sensor do not change.

According to the configuration, the minimum necessary power can be used.

As described above, according to the present disclosure, it is possible to provide a massage device capable of adjusting the position of the treatment member with respect to an arm.

### BRIEF DESCRIPTION OF THE DRAWINGS

FIG. 1 is a perspective view of a massage device according to a first embodiment;

FIG. 2 is a view illustrating a configuration of an armrest included in the massage device according to the first embodiment;

FIG. 3 is a functional block diagram of the massage device according to the first embodiment;

FIG. 4 is an enlarged perspective view illustrating a configuration of an arm accommodating portion included in the massage device according to the first embodiment in a state where the arm treatment portion is at a front end position;

FIG. 5 is an enlarged perspective view illustrating a configuration of the arm accommodating portion in a state where the arm treatment portion is at the front end position;

FIG. 6 is an enlarged perspective view illustrating a configuration of the arm accommodating portion in a state where the arm treatment portion is at the back end position;

FIG. 7 is a flowchart of basic forearm detection in the massage device according to the first embodiment;

FIG. 8 is a schematic view for describing that the arm treatment portion moves independently of the movement of the backrest and the arm accommodating portion in the massage device according to the first embodiment;

FIG. 9 is a perspective view of a massage device according to a second embodiment;

FIG. 10 is a schematic view for describing that an arm accommodating portion moves independently of the movement of a backrest in the massage device according to the second embodiment; and

FIG. 11 is a flowchart of detection of a forearm in the massage device according to the second embodiment.

### DETAILED DESCRIPTION OF EMBODIMENTS

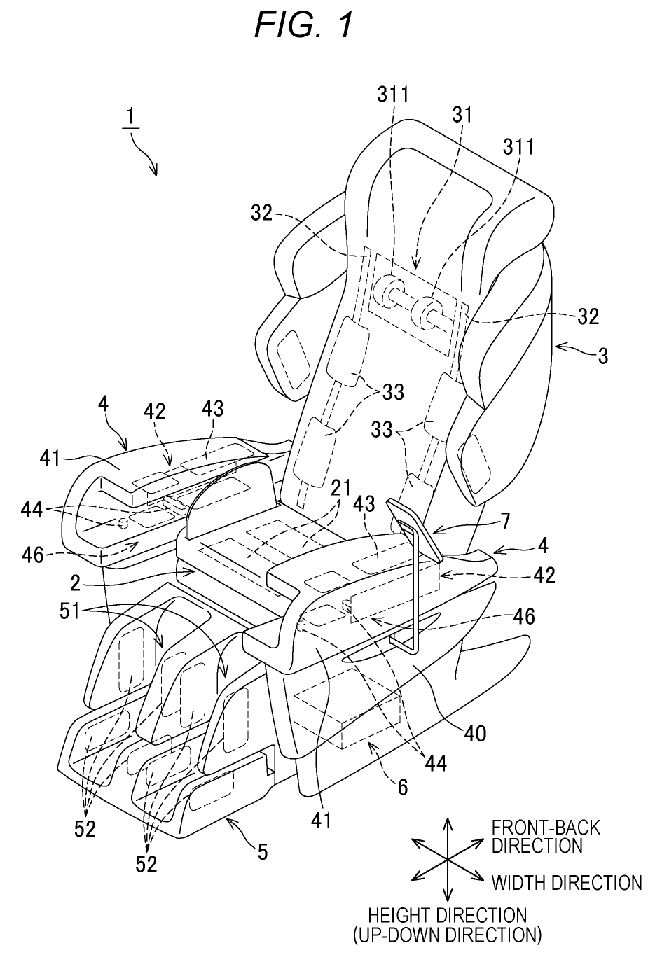

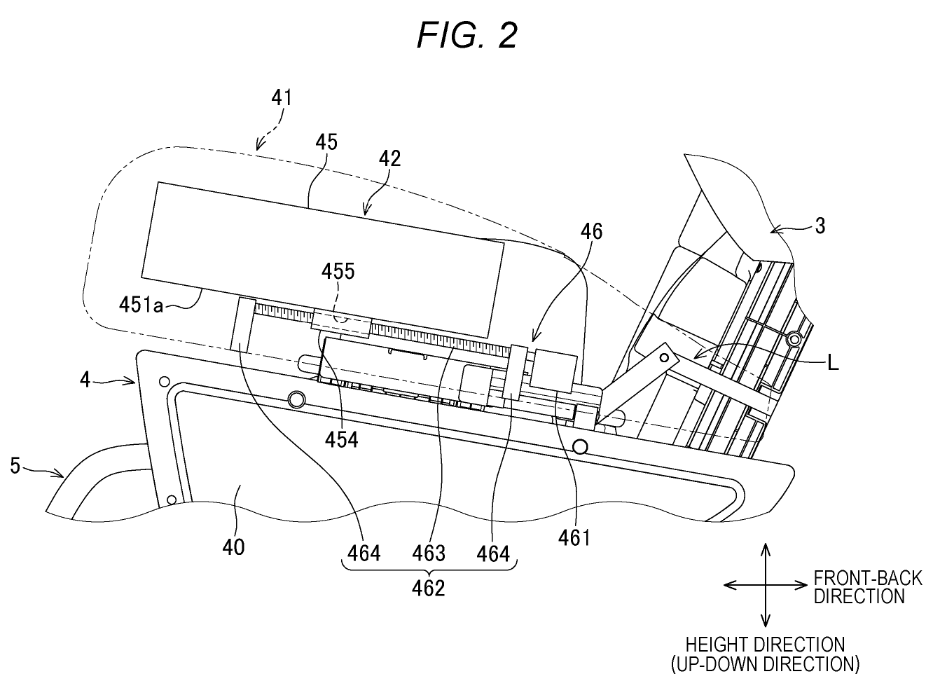

Hereinafter, a first embodiment of the present disclosure will be described with reference to FIGS. 1 to 8. Directions used in the following description are directions of a massage device 1 illustrated in FIG. 1. Specifically, the height direction of the person to be treated sitting on the massage device 1 is referred to as a “height direction” or an “up-down direction”, the left-right direction of a person to be treated (body width direction) is referred to as a “width direction” or a “left-right direction”, and the front-back direction of a person to be treated is referred to as a “front-back direction”. The correspondence relationship between the directions is as illustrated in FIG. 2 and other figures. In the present embodiment, the arm of the person to be treated refers to a part from the base of the upper arm to the fingertip. The forearm is a part on the fingertip side of the arm with respect to the elbow, and includes a hand.

As illustrated in FIGS. 1 to 3, the massage device 1 of the present embodiment is a chair-type massage device. The massage device 1 includes, on each of left and right sides thereof, a plurality of treatment members 43 that treat a corresponding forearm of a person to be treated, a detection portion or detector 44 that detects the corresponding forearm, and a drive portion or driver 46 that moves the treatment members 43 in the longitudinal direction of the corresponding forearm based on the detection information from the detection portion 44. The massage device 1 also includes a control portion or electronic controller 6 capable of controlling the drive portion 46. As well known in the field of massage device, the control portion 6 includes at least one processor having a CPU (Central Processing Unit) and a storage device or computer memory, and an interface for communicating with each device is included as necessary. In the following description, moving includes, for example, sliding or stepwise movement. In the illustrated embodiment, the left and right sides of the massage device 1 have substantially similar configurations. Therefore, only one side will be described in detail below, and detailed description of the other side will be omitted for the sake of brevity.

Specifically, the massage device 1 includes a seat 2, a backrest 3 disposed behind the seat 2, a pair of armrests 4 disposed on both left and right sides of the seat 2, an ottoman 5 disposed in front of the seat 2, and a base (not illustrated) serving as a base of the seat 2, the backrest 3, the armrests 4, and the ottoman 5. The massage device 1 also includes the control portion 6 that controls operations and the like of the backrest 3, the armrests 4, and the ottoman 5 of the massage device 1. In addition, the massage device 1 includes a remote control (operation portion) 7 for a person to be treated to operate the massage device 1.

The base is disposed below the seat 2.

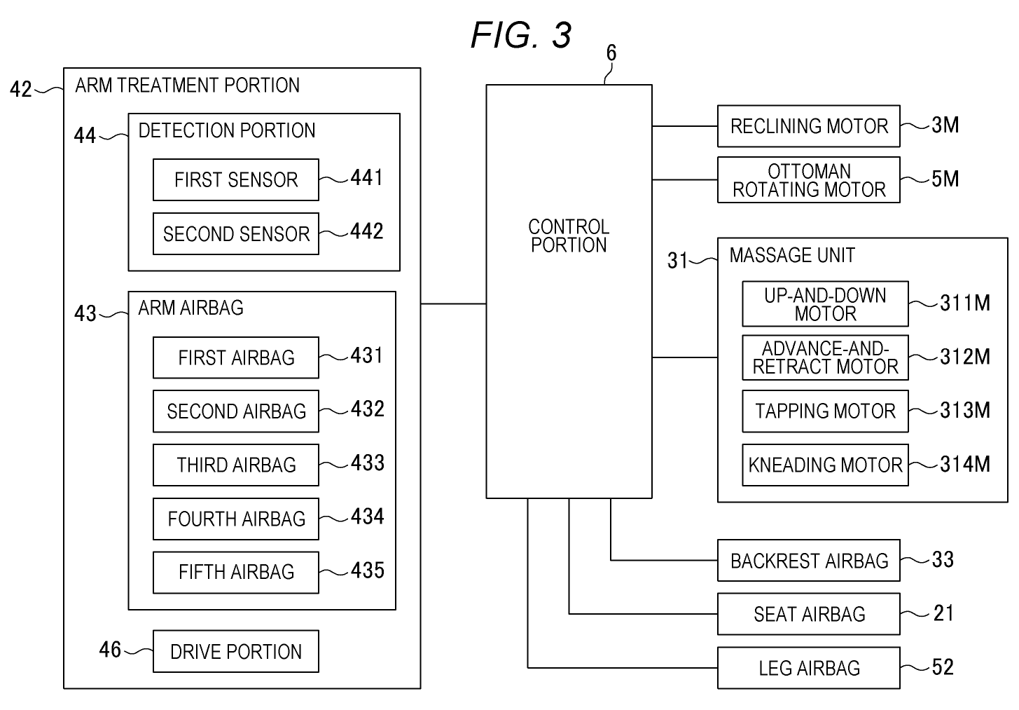

The backrest 3 can tilt (tilt backward and return upright) with respect to the seat 2, and tilt by driving of a reclining motor 3M (see FIG. 3). The backrest 3 includes a massage unit (treating unit) 31 and a pair of guide rails 32 that guide the massage unit 31 in the up-down direction along the backrest 3. The backrest 3 includes a plurality of backrest airbags (treatment members) 33 therein, and treats the upper body by expansion and contraction of each of the backrest airbags 33. The backrest 3 can include at least one of the massage unit 31 and the backrest airbags 33.

The pair of guide rails 32 is disposed with a space therebetween in the left-right direction, and each guide rail 32 extends in the up-down direction along the backrest 3.

The massage unit 31 includes a pair of right and left kneading balls (treatment members) 311, and performs various types of treatment (mechanical treatment) using the pair of kneading balls 311. The massage unit 31 is movable in the up-down direction along the pair of guide rails 32. The massage unit 31 includes an up-and-down motor 311M, an advance-and-retract motor 312M, a tapping motor 313M, and a kneading motor 314M (see FIG. 3).

The up-and-down motor 311M moves the massage unit 31 up and down along the guide rails 32. The advance-and-retract motor 312M changes the strength of the treatment members by moving the massage unit 31 in the front-back direction (advance and retract direction). The tapping motor 313M causes the massage unit 31 to perform a tapping operation.

The massage unit 31 performs a kneading operation using the kneading motor 314M. As described above, the massage device 1 including the massage unit 31 performs various treatments according to the body part of a person to be treated by driving the up-and-down motor 311M, the advance-and-retract motor 312M, the tapping motor 313M, and the kneading motor 314M.

Note that the massage unit 31 is not limited to have this configuration, and a mechanism for moving the treatment members, such as a mechanism for moving in the left-right direction or a mechanism for adjusting the width can be added, or a configuration without either one or more of the up-and-down motor 311M, the advance-and-retract motor 312M, the tapping motor 313M, and the kneading motor 314M can be used.

The seat 2 is a part on which a person to be treated sits, and is disposed above the base. The seat 2 includes a plurality of seat airbags (treatment members) 21 therein, and treats the buttocks and the back thighs by expansion and contraction of each of the seat airbags 21. Note that the seat 2 can be configured to rotate such that the front end portion moves up and down with the back end portion as a rotation center as the backrest 3 tilts. The seat 2 can be configured without including the seat airbags 21.

Each of the pair of armrests 4 includes an arm accommodating portion support 40 disposed at a position adjacent to the seat 2 in the left-right direction, and an arm accommodating portion 41 disposed above the arm accommodating portion support 40 and capable of accommodating a forearm of a person to be treated.

The positions of the arm accommodating portion supports 40 are fixed with respect to the installation surface of the massage device 1. As a result, the arm accommodating portion supports 40 do not move (do not change in position) even when the backrest 3 tilts. The arm accommodating portion supports 40 are fixed to the base, but can be fixed to another member.

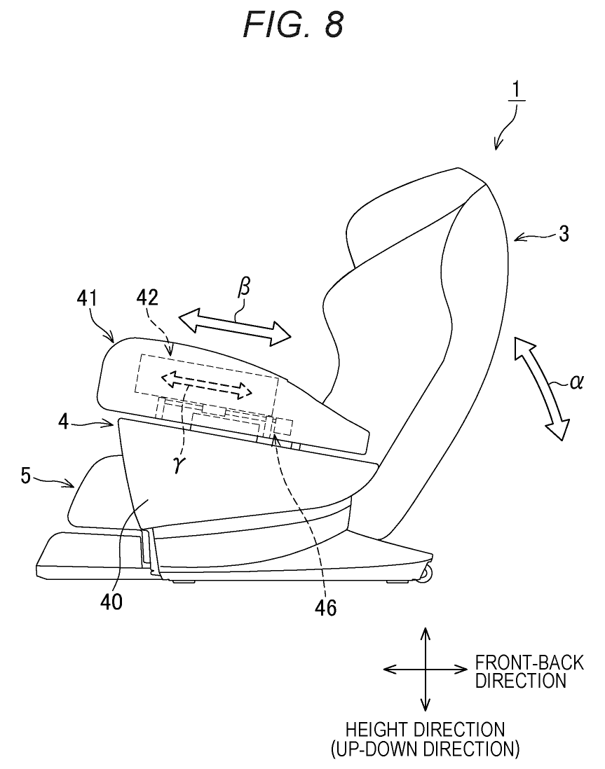

The arm accommodating portion 41 has a recess that is open (opened) at the inside in the left-right direction and that extends in the front-back direction. The arm accommodating portion 41 of the present embodiment is connected to the backrest 3 via a link mechanism L (see FIG. 2), and moves in the front-back direction with respect to the arm accommodating portion supports 40 (see the arrow β in FIG. 8) in conjunction with the tilting of the backrest 3 (see an arrow α in FIG. 8). In other words, the arm accommodating portions 41 move in the front-back direction with respect to the arm accommodating portion supports 40 as the backrest 3 is tilted.

Specifically, when the backrest 3 is tilted, the arm accommodating portions 41 move backward in conjunction with the tilting. Furthermore, when the backrest 3 returns upright, the arm accommodating portions 41 move forward in conjunction with the returning upright.

Specifically, the arm accommodating portion 41 includes an arm treatment portion 42 that treats the arm of a person to be treated and the drive portion 46 that moves the arm treatment portion 42 in the front-back direction (arm length direction). The arm accommodating portion 41 includes the arm treatment portion 42 and the drive portion 46 therein.

The arm treatment portion 42 is movable in the arm accommodating portion 41 in the front-back direction with respect to the arm accommodating portion 41. That is, the arm treatment portion 42 moves in the arm accommodating portion 41 in the front-back direction independently of the arm accommodating portion 41. The arm treatment portion 42 moves independently of the tilting of the backrest.

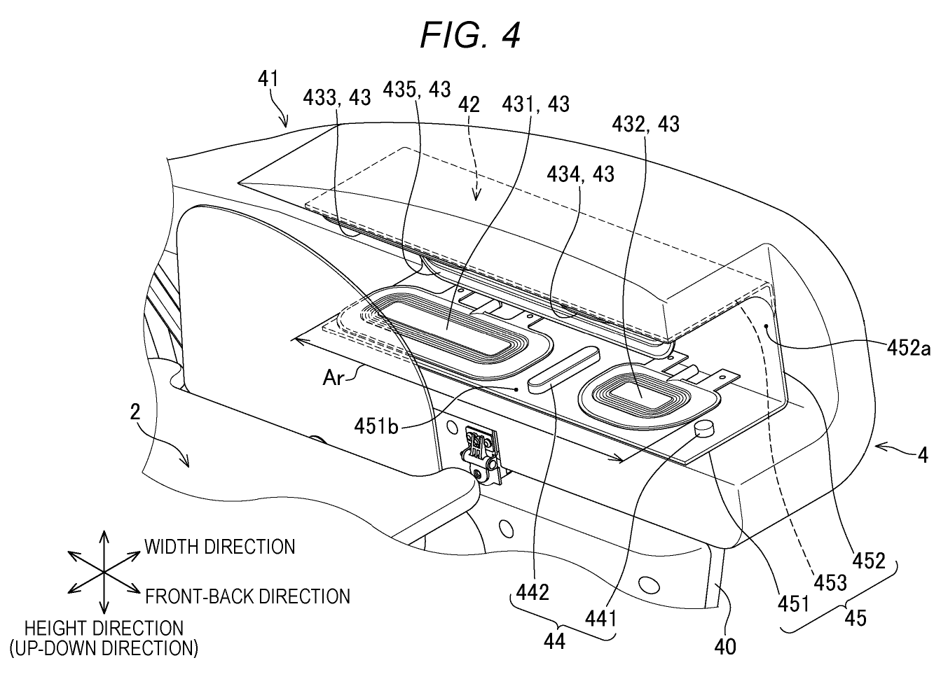

As also illustrated in FIGS. 4 to 6, the arm treatment portion 42 includes the arm airbags 43 for treating the forearm, as the treatment members 43. Specifically, the arm treatment portion 42 includes the arm airbags 43, the detection portion 44 that detects the position of the forearm, and a base portion or base 45 in which the arm airbags 43 and the detection portion 44 are disposed.

The base portion 45 has a shape conforming with the recess of the arm accommodating portion 41. Specifically, the base portion 45 includes a rectangular plate-shaped bottom wall portion 451 that extends in a direction substantially orthogonal to the up-down direction and is long in the front-back direction, rectangular plate-shaped side wall portions 452 that rise upward from the outer end portions of the bottom wall portion 451 in the left-right direction, and a rectangular plate-shaped top wall portion 453 that extends inward in the left-right direction in parallel or substantially parallel to the bottom wall portion 451 from the upper end portions of the side wall portions 452. The top wall portion 453 does not need to be parallel to the bottom wall portion 451 as long as the top wall portion 453 covers the bottom wall portion 451.

The base portion 45 includes an engagement portion 454 that protrudes downward from a lower surface 451a of the bottom wall portion 451 and that engages with the drive portion 46 (see FIG. 2). The engagement portion 454 has a threaded hole 455 penetrating the engagement portion 454 in the front-back direction, and the threaded hole 455 and the drive portion 46 (a moving screw shaft 463 to be described below: see FIG. 2) are engaged with each other. The base portion 45 moves in the front-back direction (specifically, the direction in which the moving screw shaft 463 extends) when the driving force from the drive portion 46 is transmitted to the engagement portion 454.

The plurality of the arm airbags 43 are disposed in the base portion 45. That is, the arm treatment portion 42 includes the plurality of arm airbags 43. The arm treatment portion 42 of the present embodiment includes five arm airbags (a first airbag 431, a second airbag 432, a third airbag 433, a fourth airbag 434, and a fifth airbag 435). The inflation and deflation of each of the plurality of airbags can press a suitable position of the forearm. Furthermore, for example, the arm treatment portion 42 is also used for stretching the arm by holding the forearm, particularly a part near the wrist. The number of the arm airbags 43 can be one, and for example, the arm airbag 43 can be expanded to hold the forearm between the base portion 45 and the arm airbag 43.

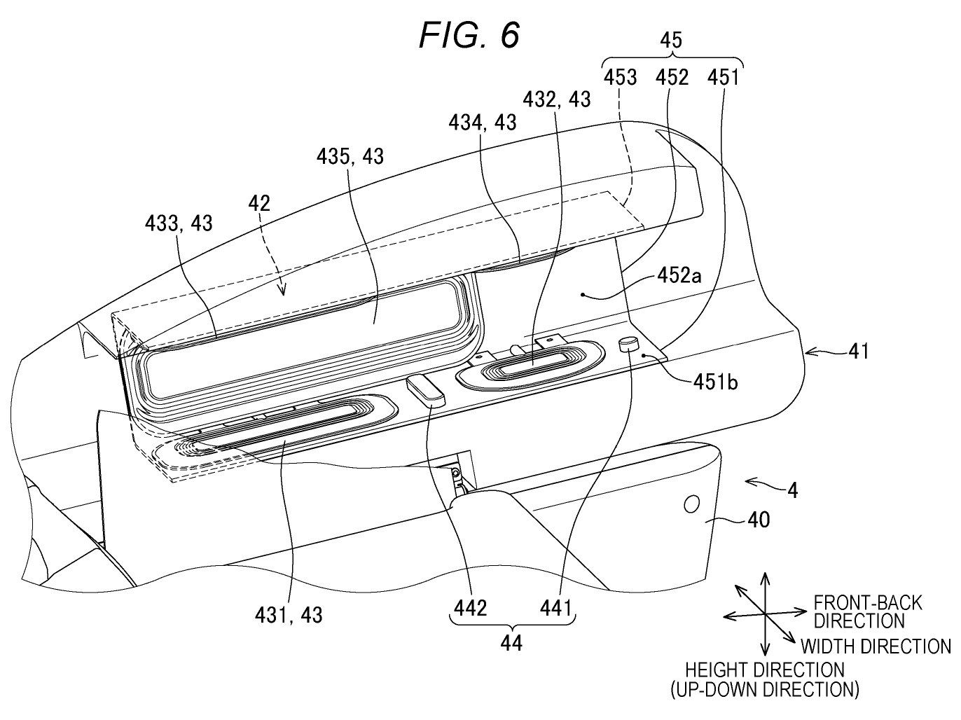

The first airbag 431 and the second airbag 432 are disposed on an upper surface 451b of the bottom wall portion 451 of the base portion 45. More specifically, the first airbag 431 and the second airbag 432 are disposed on the upper surface 451b of the bottom wall portion 451 with a space therebetween in the front-back direction (see FIGS. 4 and 6). As a result, a space for disposing a second sensor 442 to be described below is formed between the first airbag 431 and the second airbag 432.

In the arm treatment portion 42, for example, the dimension of the first airbag 431 in the front-back direction is larger than the dimension of the second airbag 432 in the front-back direction. Specifically, the dimension of the first airbag 431 in the front-back direction corresponds to the dimension of the forearm excluding the hand, and the dimension of the second airbag 432 in the front-back direction corresponds to the dimension of the hand.

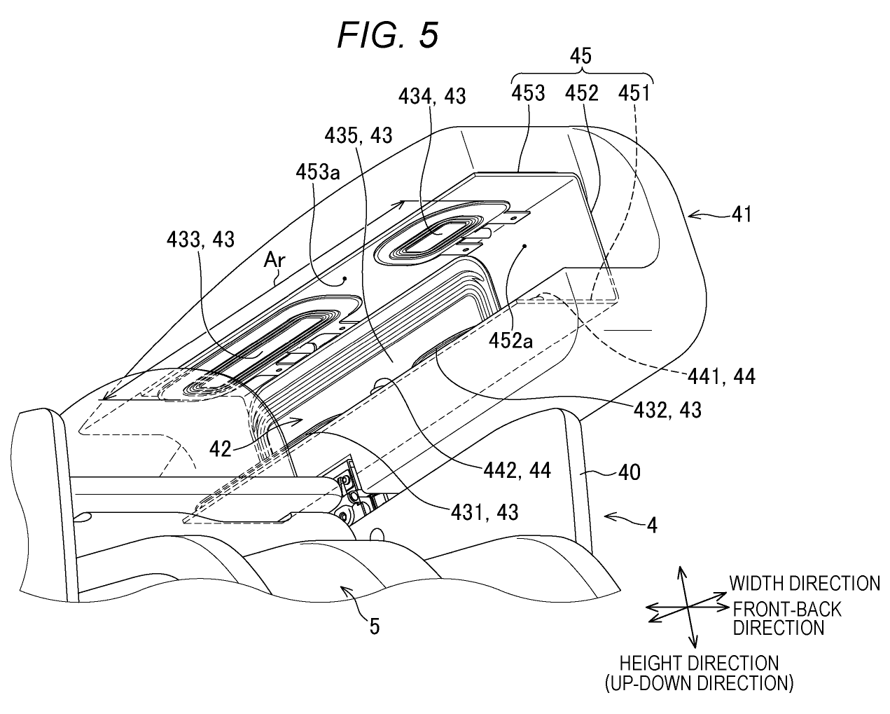

The third airbag 433 and the fourth airbag 434 are disposed on the top wall portion 453 of the base portion 45. More specifically, the third airbag 433 and the fourth airbag 434 are disposed on the lower surface 453a of the top wall portion 453 with a space therebetween in the front-back direction (see FIG. 5). A space is not necessarily formed between the third airbag 433 and the fourth airbag 434.

In the arm treatment portion 42, for example, the dimension of the third airbag 433 in the front-back direction is larger than the dimension of the fourth airbag 434 in the front-back direction. Specifically, the dimension of the third airbag 433 in the front-back direction corresponds to the dimension of the forearm excluding the hand, and the dimension of the fourth airbag 434 in the front-back direction corresponds to the dimension of the hand.

The third airbag 433 is disposed at a position facing the first airbag 431. As a result, when the forearm is at a suitable position with respect to the arm treatment portion 42, the first airbag 431 and the third airbag 433 can inflate to press or hold the forearm so as to sandwich the forearm excluding the hand. The fourth airbag 434 is disposed at a position facing the second airbag 432. As a result, when the forearm is at a suitable position with respect to the arm treatment portion 42, the second airbag 432 and the fourth airbag 434 can inflate to press or hold the hand so as to sandwich the hand. The dimension of the third airbag 433 in the front-back direction can be the same as or different from the dimension of the first airbag 431 in the front-back direction. The dimension of the fourth airbag 434 in the front-back direction can be the same as or different from the dimension of the second airbag 432 in the front-back direction.

The detection portion 44 moves with the movement (for example, slide) of the arm treatment portion 42 in the front-back direction. Since the detection portion 44 of the present embodiment is disposed in the base portion 45, the detection portion moves by the same distance as the moving distance (for example, the slide distance) of the arm treatment portion 42 with the movement (for example, slide) of the arm treatment portion 42 in the front-back direction. The detection portion 44 includes, for example, a plurality of sensors (a first sensor 441 and the second sensor 442). The detection portion 44 of the present embodiment includes the first sensor 441 and the second sensor 442 disposed at a position spaced apart backward from the first sensor 441. The first sensor 441 and the second sensor 442 are electrically connected to the control portion 6.

The first sensor 441 is disposed in front of the disposition area Ar for the arm airbags 43 in the arm treatment portion 42. Specifically, the first sensor 441 protrudes upward from a position in front of the second airbag 432 on the upper surface 451b of the bottom wall portion 451 of the base portion 45. The first sensor 441 of the present embodiment is a touch sensor, and detects the forearm of a person to be treated when the forearm (specifically, a hand) comes into contact with the first sensor. The first sensor 441 transmits a signal (detection information) indicating that the forearm is detected to the control portion 6. The disposition area Ar is a region where the arm airbags 43 are disposed on the bottom wall portion 451 and the top wall portion 453 (in other words, an area where pairs of arm airbags 43 facing each other with a space therebetween in the up-down direction are disposed). More specifically, the disposition area Ar is a range from the back ends of the first airbag 431 and the third airbag 433 (backmost ends in the direction in which the first airbag 431 and the second airbag 432 are disposed) to the front ends of the second airbag 432 and the fourth airbag 434 (frontmost ends in the direction in which the first airbag 431 and the second airbag 432 are disposed).

The second sensor 442 is disposed in the disposition area Ar for the arm airbags 43 in the arm treatment portion 42. Specifically, the second sensor 442 protrudes upward from a position between the first airbag 431 and the second airbag 432 on the upper surface 451b of the bottom wall portion 451 of the base portion 45. Thus, the second sensor 442 is located behind the first sensor 441 in the front-back direction or in the longitudinal direction of the forearm. The second sensor 442 is a touch sensor, and detects the forearm of a person to be treated when the forearm (specifically, a part near the wrist) comes into contact with the second sensor. The second sensor 442 transmits a signal (detection information) indicating that the forearm is detected to the control portion 6. The second sensor 442 extends in the left-right direction, but is not limited to have this configuration. The second sensor 442 is not necessarily disposed in the disposition area Ar. The second sensor 442 can be disposed behind the first airbag 431, for example. That is, the second sensor 442 can be disposed at any place where the second sensor 442 can detect an arm (particularly, a forearm).

The drive portion 46 can change the position of the arm treatment portion 42 in the front-back direction independently of the movement (tilting) of the backrest 3 (see arrows α, β, and γ in FIG. 8). That is, the drive portion 46 can drive (operate) the arm treatment portion 42 independently of the reclining operation of the massage device 1. In addition, the driving of the arm treatment portion 42 by the drive portion (right drive portion) 46 in the arm accommodating portion 41 of the right armrest 4 and the driving of the arm treatment portion 42 by the drive portion (left drive portion) 46 in the arm accommodating portion 41 of the left armrest 4 can be performed independently of each other. That is, the arm treatment portion 42 in the arm accommodating portion 41 of the right armrest 4 and the arm treatment portion 42 in the arm accommodating portion 41 of the left armrest 4 can move independently (for example, alternately) in the front-back direction. Note that the driving of the arm treatment portion 42 by the right drive portion and the driving of the arm treatment portion 42 by the left drive portion can be performed in conjunction with each other (in synchronization).

The drive portion 46 includes a drive source 461 and a transmission mechanism 462 that transmits a driving force output from the drive source 461 to the arm treatment portion 42 (see FIG. 2). In the illustrated embodiment, the drive source 461 includes an electronic actuator or motor that outputs the driving force, for example.

The transmission mechanism 462 includes the moving screw shaft 463 extending in the front-back direction and a pair of supports 464 that supports both ends of the moving screw shaft 463.

The pair of supports 464 supports the moving screw shaft 463 in a state of being rotatable about the central axis of the moving screw shaft 463 in the front-back direction. The lower end of each of the supports 464 is fixed at a position in the front-back direction with respect to the arm accommodating portion supports 40 of the armrest 4. As a result, the position of the drive portion 46 in the front-back direction is fixed with respect to the arm accommodating portion supports 40, and the drive portion 46 does not move in the front-back direction with respect to the arm accommodating portion supports 40 even if the backrest 3 tilts. As a result, even when the arm accommodating portion 41 moves in the front-back direction with respect to the arm accommodating portion supports 40 due to the tilting of the backrest 3, the position of the arm treatment portion 42 in the front-back direction is fixed with respect to the arm accommodating portion supports 40 via the drive portion 46. Therefore, the arm treatment portion 42 does not move in the front-back direction mechanically in conjunction with the tilting of the backrest 3.

A male screw is formed on the peripheral surface of the moving screw shaft 463, and the moving screw shaft 463 is supported by the pair of supports 464 in a state of being inserted through the threaded hole 455 of the engagement portion 454 of the arm treatment portion 42 (base portion 45). When the moving screw shaft 463 is inserted through the engagement portion 454, the male screw on the outer peripheral surface of the moving screw shaft 463 and the female screw on the inner peripheral surface of the threaded hole 455 of the engagement portion 454 are engaged (screwed) with each other. As a result, the moving screw shaft 463 rotates about the central axis, so that the engagement portion 454 moves along the moving screw shaft 463.

The drive source 461 rotationally drives the moving screw shaft 463 about the central axis. The drive source 461 is a motor having an output shaft, and the output shaft is connected to one end of the moving screw shaft 463. As a result, operation of the drive source 461 (rotation of the output shaft of the drive source 461) rotates the moving screw shaft 463 about the central axis.

In the arm accommodating portion 41 configured as described above, the arm treatment portion 42 moves in the front-back direction between the position illustrated in FIG. 4 and the position illustrated in FIG. 6. Specifically, operation of the drive source 461 rotates the moving screw shaft 463 about the central axis. When the moving screw shaft 463 rotates about the central axis, the engagement portion 454 moves in the central axis direction of the moving screw shaft 463. That is, the arm treatment portion 42 moves along the moving screw shaft 463. As a result, the arm treatment portion 42 moves in the front-back direction with respect to the arm accommodating portion 41 such that the arm airbags 43 of the arm treatment portion 42 are at positions suitable for treatment with respect to the forearm accommodated in the arm accommodating portion 41.

In the arm accommodating portion 41, airbag pairs (the pair of the first airbag 431 and the third airbag 433, and the pair of the second airbag 432 and the fourth airbag 434) facing each other in the up-down direction hold the forearm by sandwiching the forearm. The massage device 1 stretches the upper body or the arm of a person to be treated by holding the arm by the airbag pairs.

For example, the control portion 6 can move the right arm treatment portion 42 and the left arm treatment portion 42 in opposite directions in the front-back direction in a state where the forearms of both arms are held by the arm treatment portions 42 (specifically, the airbag pairs). When the right arm treatment portion 42 and the left arm treatment portion 42 move in opposite directions in the front-back direction, the upper body of the person to be treated is twisted (that is, the upper body is stretched). Furthermore, for example, the control portion 6 can move the arm treatment portion 42 forward in a state where at least one forearm is held by the arm airbags 43. As a result, the control portion 6 can stretch the arm by pulling the arm. Furthermore, for example, the control portion 6 can move the backrest 3 from the upright state to the tilted state in a state where at least one forearm is held by the arm airbags 43. As a result, the arm can be stretched by pulling the arm. In the illustrated embodiment, for simplicity of description, the expression that the control portion 6 moves (or stops/stops movement of) the arm treatment portion 42 (or the treatment member 43) or the expression that the drive portion 46 moves (or stops/stops movement of) the arm treatment portion 42 (or the treatment member 43) is intended to mean that the control portion 6 controls or operates the drive portion 46 to move (or stop/stops movement of) the arm treatment portion 42 (or the treatment member 43).

Referring again to FIG. 1, the ottoman 5 is disposed so as to be rotatable about an ottoman rotating shaft provided near the front end portion of the seat 2 and extending in the left-right direction and rotates by driving an ottoman rotating motor 5M (see FIG. 3). The ottoman 5 is rotatable between a vertical posture and a horizontal posture. The ottoman 5 includes a pair of leg accommodating recesses (treatment portions) 51 that accommodates left and right legs and feet of a person to be treated.

Each leg accommodating recess 51 includes a plurality of leg airbags (treatment members) 52 therein, and treats the leg and the foot by expansion and contraction of the leg airbags 52.

The control portion 6 can combine the movement of the ottoman 5 with stretching by pulling the arm. Thus, the massage device 1 can stretch both the arms and the legs.

The control portion 6 controls the movements of the backrest 3, the armrests 4, and the ottoman 5 by operation of a remote control 7. Specifically, the control portion 6 is electrically connected to the backrest 3, the armrests 4, and the ottoman 5, and controls operations of the backrest 3, the armrests 4, and the ottoman 5 by controlling driving of actuators, pumps, motors, and the like. For example, the control portion 6 can adjust the amount of air supplied to the arm airbags 43 by a person to be treated operating the remote control 7. In addition, the control portion 6 moves the arm treatment portion 42 when the person to be treated operates the remote control 7. As a result, the massage device 1 can perform treatment preferred by the person to be treated (pressing, stretching).

The massage device 1 detects the presence or absence, or deviation of the forearm in the arm accommodating portion 41 when the forearm of a person to be treated with respect to the arm treatment portion 42 (the position in the front-back direction) is not at a position suitable for treatment or deviated from the position suitable for treatment before the start of treatment of a person to be treated (when power is turned on, or after treatment or a treatment course is selected, etc.) or during treatment. In a case where the control portion 6 determines that the position of the forearm is not at a position suitable for treatment, the control portion 6 moves the arm treatment portion 42. That is, the massage device 1 aligns the arm treatment portion 42 with respect to the position of the forearm of the person to be treated. The specific operation is described below.

The position suitable for treatment as used herein is a position at which the treatment members directly or indirectly treat the forearm. For example, the position suitable for treatment as used herein is a position where the forearm is treated by the treatment members (airbags 43). More specifically, the position suitable for treatment as used herein is a position where at least one of the first airbag 431 and the third airbag 433 can treat a part between the wrist and the elbow of the forearm, and a position where at least one of the second airbag 432 and the fourth airbag 434 can treat a part between the fingertip and the wrist.

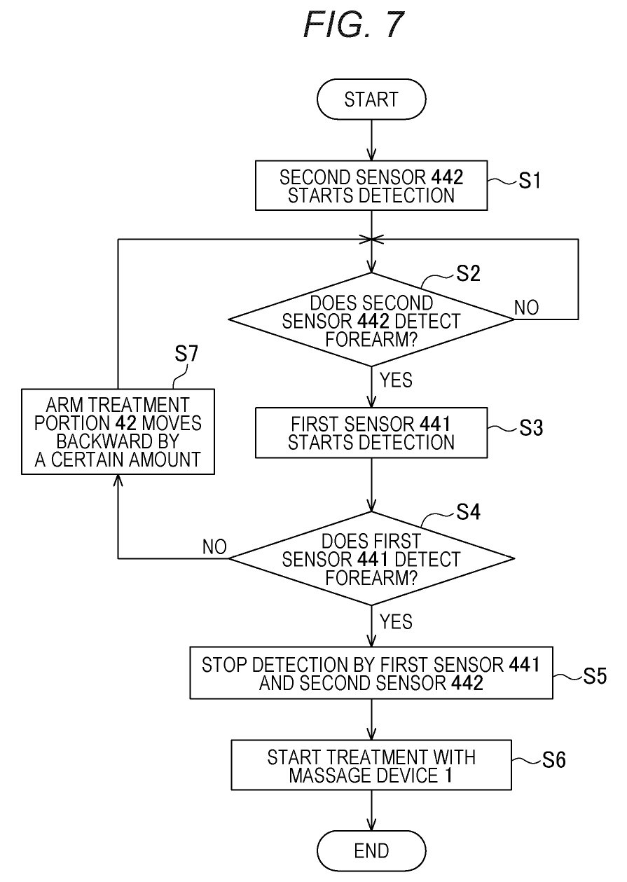

First, basic forearm detection in the massage device 1 will be described with reference to FIG. 7.

The control portion 6 starts detecting the presence or absence of the forearm of a person to be treated in the arm treatment portion 42 (step S1). More specifically, the control portion 6 detects that the forearm is present in the arm treatment portion 42 when the forearm of the person to be treated touches (or approaches) the second sensor 442. For example, before the start of treatment or during treatment in the massage device 1, the second sensor 442 detects whether the forearm is present in the arm treatment portion 42 (presence or absence of the forearm). Note that, before starting treatment, it is preferable that the massage device 1 performs detection in a state where the arm treatment portion 42 is moved to the frontmost side (the position illustrated in FIGS. 4 and 5).

When the forearm of a person to be treated does not touch the second sensor 442 and thus the forearm is not detected by the second sensor 442 (step S2: No), the control portion 6 continues to detect the presence or absence of the forearm by the second sensor 442 (repeats the operation of step S2).

On the other hand, when the forearm of a person to be treated touches the second sensor 442 and thus the control portion 6 detects the arm (step S2: Yes), the control portion 6 starts detection of the presence or absence of the distal end portion (fingertip) of the forearm by the first sensor 441 (step S3).

When the forearm is detected by the distal end portion of the forearm touching the first sensor 441 (step S4: Yes), the control portion 6 determines that the position of the forearm in the front-back direction in the arm treatment portion 42 is at a suitable position (position suitable for treatment by the treatment members 43). In a case where the distal end portion of the forearm is detected, the control portion 6 stops the detection by the detection portion 44 (the first sensor 441 and the second sensor 442) (step S5). When the control portion 6 determines, using the first sensor 441 and the second sensor 442, that the forearm of a person to be treated is at a suitable position in the arm treatment portion 42, the control portion 6 starts treatment of the person to be treated (step S6). In this case, the control portion 6 stops the movement of the arm treatment portion 42. As described above, since the forearm of the person to be treated is at a position suitable for treatment in the arm treatment portion 42, the arm treatment portion 42 can perform effective treatment.

On the other hand, when the forearm is not detected because the distal end portion of the forearm does not touch the first sensor 441 (step S4: No), the control portion 6 determines that the position of the forearm in the front-back direction in the arm treatment portion 42 is not suitable, and drives the drive portion 46 to move the arm treatment portion 42 backward by a certain amount (step S7). That is, the control portion 6 changes the position of the arm treatment portion 42 to a position backward by a certain amount. Then, when the arm treatment portion 42 moves backward by a certain amount, the control portion 6 returns to step S2 and repeats steps S2 to S4 and step S7 until the first sensor 441 detects the forearm (that is, until it is determined Yes in step S4). In this case, the processing in step S2 can be skipped.

In this manner, the second sensor 442 detects whether the forearm of the person to be treated is present in the arm treatment portion 42, and the first sensor 441 detects whether the forearm is at a suitable position. Since the forearm of the person to be treated is disposed at a suitable position, the massage device 1 suitably moves the arm treatment portion 42 such that each of the arm airbags (treatment members) 43 is at a suitable position for treatment (for example, the first airbag 431 and the third airbag 433 treat the part from the wrist to the elbow in the forearm, and the second airbag 432 and the fourth airbag 434 treat the part from the wrist to the fingertip). As a result, in the massage device 1, the control portion 6 moves the arm treatment portion 42 such that the forearm of a person to be treated is at a position suitable for treatment in the arm treatment portion 42, whereby effective massage can be performed.

In addition, a case where the backrest 3 is tilted (reclined) at the time of treatment by the massage device 1 will be described.

For example, when the control portion 6 tilts the backrest 3, the arm accommodating portion 41 of the armrest 4 moves backward in conjunction with the tilting of the backrest 3. For example, the backrest 3 can be automatically tilted before the start of treatment or during treatment. In addition, for example, the backrest 3 can be tilted by an operation by a person to be treated. In addition, for example, the backrest 3 can return upright from a tilted state automatically or by an operation by a person to be treated. At this time, the arm treatment portion 42 is fixed to the arm accommodating portion supports 40 of the armrest 4 via the drive portion 46, so that the arm treatment portion moves forward relative to the arm accommodating portion 41. As a result, the forearm of a person to be treated can deviate from a position suitable for treatment in the arm treatment portion 42.

The control portion 6 moves the arm treatment portion 42 to a position suitable for treatment with respect to the forearm based on detection by the first sensor 441 and the second sensor 442 from a state where the forearm is deviated from a position suitable for treatment in the arm treatment portion 42 due to tilting of the backrest 3 (see FIG. 7).

More specifically, when the second sensor 442 detects the forearm and the first sensor 441 does not detect the forearm (step S4: No), the control portion 6 moves the arm treatment portion 42 backward by a certain amount (S7). Then, the control portion 6 repeats steps S2 to S4 in FIG. 7 until the first sensor 441 detects the forearm.

In addition, for example, the backrest 3 can return upright from a tilted state automatically or by an operation by a person to be treated. In this case, the arm treatment portion 42 relatively moves backward with respect to the arm accommodating portion 41. When the arm treatment portion 42 relatively moves backward with respect to the arm accommodating portion 41, the forearm can be deviated to a position not detected by the second sensor 442. As described above, even when the backrest 3 moves to the upright state and the second sensor 442 does not detect the forearm, the first sensor 441 can start detection of the forearm. For example, when the detection information from the second sensor 442 changes, the first sensor 441 can start detection of the forearm. More specifically, the first sensor 441 can detect the forearm when the detection information from the second sensor 442 changes, during the treatment, from the detection information indicating that the forearm is detected to the detection information indicating that the forearm is not detected. In such a case, when the first sensor 441 detects the forearm, the arm treatment portion 42 is moved to forward.

The massage device 1 of the present embodiment includes the arm airbags (treatment members) 43 that treat the forearm of a person to be treated, the detection portion 44 that detects the forearm, and the drive portion 46 that moves the arm airbags 43 in the longitudinal direction of the forearm based on the detection information from the detection portion 44.

According to the massage device 1, the detection portion 44 detects the position of the forearm, and the arm airbags 43 move, whereby the positions of the arm airbags 43 with respect to the forearm can be adjusted. As a result, in the massage device 1, the forearm is disposed at a suitable position in the arm treatment portion 42, and the massage device 1 can perform more effective treatment.

The massage device 1 according to the present embodiment includes the arm treatment portion 42 including the arm airbags (treatment members) 43 and the detection portion 44, and the arm treatment portion 42 moves in the longitudinal direction of the forearm based on detection information from the detection portion 44.

According to the configuration, the arm airbags 43 can move together with the arm treatment portion 42 while maintaining the relative position with respect to the detection portion 44. As a result, the massage device 1 can accurately detect whether the forearm is at a suitable position with respect to the arm airbags 43 even when the arm airbags 43 and the detection portion 44 move in the front-back direction to align the forearm with respect to the arm airbags 43.

The detection portion 44 of the present embodiment includes the first sensor 441 and the second sensor 442 disposed at the arm treatment portion 42. The first sensor 441 is disposed at a front portion of the arm treatment portion in the longitudinal direction of the forearm or in the front-back direction. The second sensor 442 is disposed or located behind the first sensor 441 in the longitudinal direction of the forearm or in the front-back direction. In this manner, the detection portion 44 can detect the presence or absence of the forearm with the second sensor 442 and detect whether the forearm is at the correct position with the first sensor 441. As a result, the massage device 1 can detect whether the forearm is present in the arm treatment portion 42 and the position of the forearm in the arm treatment portion 42.

The massage device 1 of the present embodiment includes the backrest 3 tiltable with respect to the installation surface on which the massage device 1 is installed, and the arm airbags (treatment members) 43 move independently of the tilting of the backrest 3. As a result, the massage device 1 can adjust the positions of the arm airbags 43 with respect to the forearm regardless of the tilting of the backrest 3.

The drive portion 46 of the present embodiment moves the arm airbags (treatment members) 43 based on the detection information from both the first sensor 441 and the second sensor 442.

As described above, the arm airbags 43 move based on the detection information from the first sensor 441 and the second sensor 442 spaced apart in the longitudinal direction of the forearm, whereby the arm treatment portion 42 can accurately move to a position suitable for treatment with respect to the forearm in the longitudinal direction of the forearm.

The drive portion 46 of the present embodiment moves the arm airbags (treatment members) 43 based on the detection information from both the first sensor 441 and the second sensor 442.

As described above, the arm airbags 43 are moved based on the detection information from the first sensor 441 and the second sensor 442 spaced apart in the longitudinal direction of the forearm, whereby the drive portion 46 can accurately move the arm airbags 43 to positions suitable for treatment of the forearm in the longitudinal direction of the forearm.

In the massage device 1 of the present embodiment, the drive portion 46 stops the movement of the arm airbags (treatment members) 43 when both the first sensor 441 and the second sensor 442 detect the forearm in the detection portion 44.

According to the configuration, the massage device 1 can prevent the arm airbags 43 from moving when detecting that the forearm is at a position suitable for treatment.

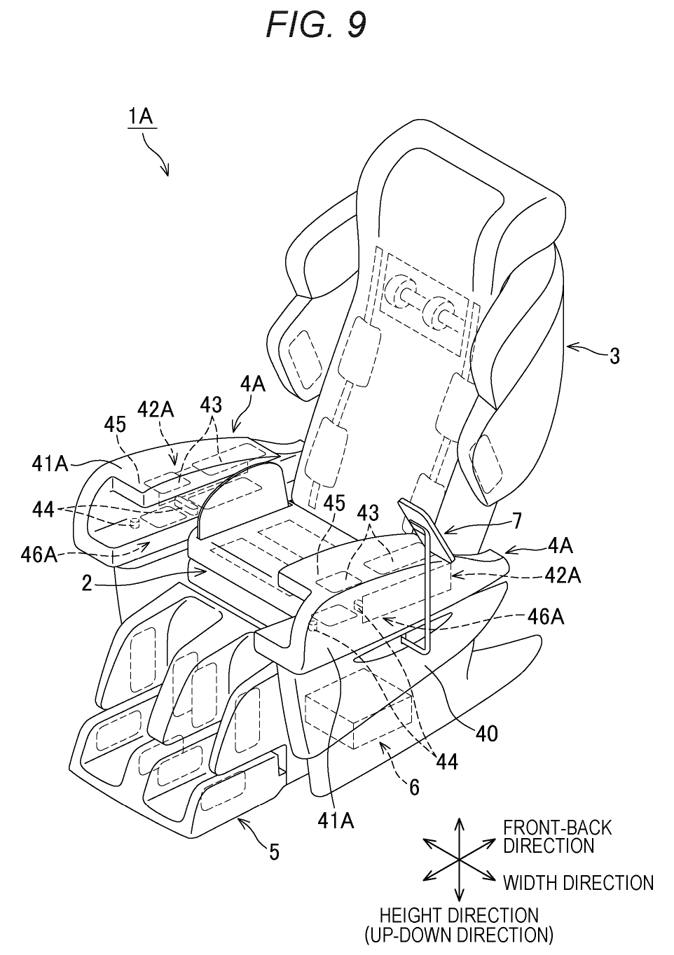

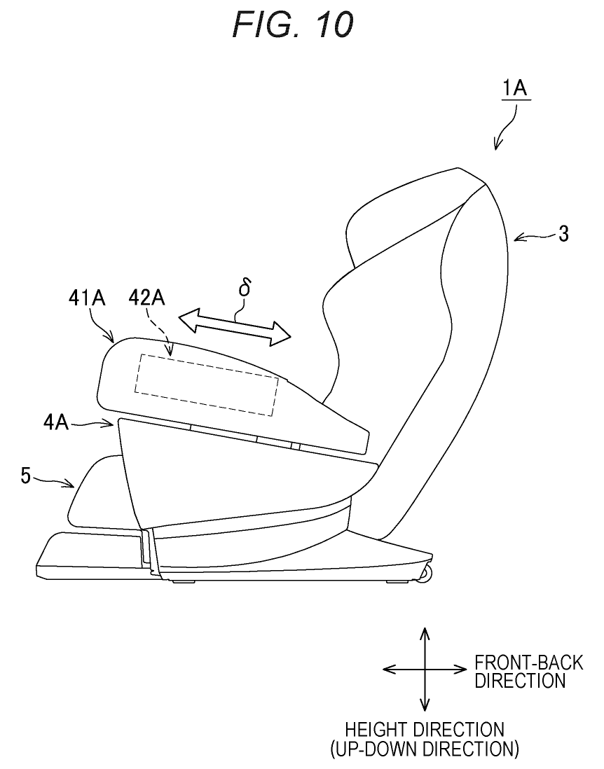

Next, a second embodiment of the present disclosure will be described with reference to FIGS. 9 and 10. The same reference numerals are used for the same components as those of the first embodiment, and detailed description thereof is not provided, and only different components will be described in detail.

The massage device 1A of the present embodiment includes a seat 2, a backrest 3, a pair of armrests 4A, an ottoman 5, a base, a control portion 6, and a remote control (operation portion) 7.

Each of the pair of armrests 4A includes an arm accommodating portion support 40 disposed at a position adjacent to the seat 2 in the left-right direction, and an arm accommodating portion 41A disposed above the arm accommodating portion support 40 and capable of accommodating an arm of a person to be treated.

The arm accommodating portion 41A has a recess that is open (opened) at the inside in the left-right direction and that extends in the front-back direction. The arm accommodating portions 41A of the present embodiment can move (for example, slide) in the front-back direction with respect to the arm accommodating portion supports 40 independently of the tilting of the backrest 3 (see an arrow δ in FIG. 10). Specifically, the arm accommodating portion 41A includes an arm treatment portion 42A and a drive portion 46A that moves the arm accommodating portion 41A in the front-back direction (arm length direction).

The arm treatment portion 42A is fixed to the arm accommodating portion 41A. As a result, the arm treatment portion 42A moves together with the arm accommodating portion 41A when the arm accommodating portion 41A moves with respect to the arm accommodating portion supports 40. Specifically, the arm treatment portion 42A includes arm airbags (treatment members) 43, a detection portion 44 including a first sensor 441 and a second sensor 442, and a base portion 45.

The drive portion 46A can change the positions of the arm accommodating portions 41A in the front-back direction independently of the movement (tilting) of the backrest 3. That is, the drive portion 46A of the present embodiment can drive (operate) the arm accommodating portions 41A independently of the reclining operation of the massage device 1A. In addition, the driving of the arm accommodating portion 41A by the drive portion 46A of the right armrest 4A and the driving of the arm accommodating portion 41A by the drive portion 46A of the left armrest 4A can be performed independently of each other. That is, the arm accommodating portion 41A in the right armrest 4A and the arm accommodating portion 41A in the left armrest 4A can be moved independently (for example, alternately) in the front-back direction. Note that the driving of the arm accommodating portion 41A by the drive portion 46A of the right armrest 4A and the driving of the arm accommodating portion 41A by the drive portion 46A of the left armrest 4A can be performed in conjunction (in synchronization).

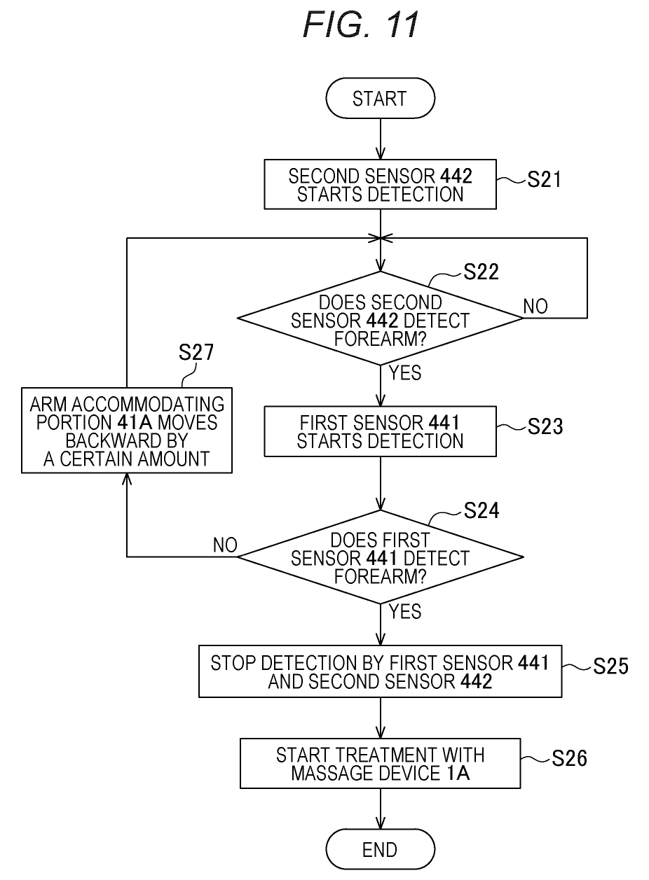

In the massage device 1A, the arm treatment portions 42A move as the arm accommodating portions 41A move. That is, as the arm accommodating portions 41A move, the detection portions 44 and the arm airbags 43 also move. In the massage device 1A, the arm accommodating portions 41A move with respect to the arm accommodating portion supports 40 independently of the tilting of the backrest 3. Therefore, only basic forearm detection will be described with reference to FIG. 11. FIG. 11 differs from FIG. 7 only in step S27. Therefore, in the following description, the same parts as those in FIG. 7 will not be described.

When the first sensor 441 does not detect the forearm (step S24: No), the control portion 6 drives the drive portion 46A to move the arm accommodating portion 41A backward by a certain amount (step S27). As a result, the arm treatment portion 42A also moves backward by a certain amount together with the arm accommodating portion 41A. Then, when the arm accommodating portion 41 moves backward by a certain amount, the control portion 6 returns to step S22 and repeats steps S22 to S24 and step S27 until the first sensor 441 detects the forearm (that is, until it is determined Yes in step S24). Note that, in this case, the control portion 6 can skip the processing of step S22.

The massage device 1A of the present embodiment includes the arm airbags (treatment members) 43 that treat the forearm of a person to be treated, the detection portion 44 that detects the forearm, and the drive portion 46A that moves the arm airbags 43 in the longitudinal direction of the forearm based on the detection information from the detection portion 44. As a result, the detection portion 44 detects the position of the forearm and the arm airbags 43 move, so that the massage device 1A can adjust the position of the arm airbags 43 with respect to the forearm. As a result, similarly to the massage device 1 according to the first embodiment, in the massage device 1A, the forearm is disposed at a suitable position in the arm treatment portion 42A, and the massage device 1A can perform more effective treatment.

The massage device of the present invention is not limited by the above-described embodiments, and various modifications can be made without departing from the gist of the present invention. For example, a component of another embodiment can be added to the components of an embodiment, and a part of the components of one embodiment can be replaced with a component of another embodiment. Further, a part of the components of an embodiment can be deleted.

The massage devices 1 and 1A according to the first and second embodiments are chair-type massage devices, but the present invention is not limited to the configurations. The massage devices 1 and 1A can be a massage seat or the like. That is, the massage devices 1 and 1A can include at least the backrest 3 and the treatment members 43 that treat an arm.

In each of the massage devices 1 and 1A according to the first embodiment and the second embodiment, the arm accommodating portions 41 move with respect to the arm accommodating portion supports 40, but the present invention is not limited to the configuration. The arm accommodating portions 41 can be fixed to the arm accommodating portion supports 40 (that is, in a non-movable state in the front-back direction). In this case, it is sufficient that the arm treatment portions 42 can move in the front-back direction with respect to the arm accommodating portion support units 40 based on the detection by the detection portion 44. Even with this configuration, in the massage devices 1 and 1A, even if the forearm is deviated in the front-back direction from the position suitable for treatment with respect to the treatment members (arm airbags) 43, the arm treatment portions 42 move to adjust the positions of the treatment members 43 with respect to the forearm.

In the massage devices 1 and 1A according to the first embodiment and the second embodiment, the treatment members 43 of the right arm treatment portions 42 and 42A and the treatment members 43 of the left arm treatment portions 42 and 42A can move independently in the movement in the front-back direction (can move or operate differently from each other), but the present invention is not limited to this configuration. The treatment members 43 of the right arm treatment portions 42 and 42A and the treatment members 43 of the left arm treatment portions 42 and 42A can perform the same movement (synchronized movement) in the movement in the front-back direction.

In addition, the arm accommodating portions 41 and 41A of the massage devices 1 and 1A according to the first embodiment and the second embodiment have a recess shape that is open at the inside in the left-right direction and that extends in the front-back direction, but the present invention is not limited to this configuration. The arm accommodating portions 41 and 41A can have a recess shape that is open at the upper side and that extends in the front-back direction, a cylindrical shape extending in the front-back direction, a bottomed cylindrical shape with a back end opened and extending in the front-back direction, or the like. In this case, the second sensor 442 can be disposed at the front end.

The detection portion 44 of each of the massage devices 1 and 1A according to the first and second embodiments includes two sensors (the first sensor 441 and the second sensor 442), but the present invention is not limited to this configuration. The number of sensors included in the detection portion 44 can be one or three or more. The detection portion 44 only needs to be able to detect whether the forearm is at a suitable position in the front-back direction (position suitable for treatment).

In the massage devices 1 and 1A according to the first and second embodiments, the first sensor 441 and the second sensor 442 are touch sensors, but the present invention is not limited to this configuration. The first sensor 441 and the second sensor 442 can be a photoelectric sensor, a human sensor, a distance sensor, a photosensor, or the like. That is, the type (detection method) of the first sensor 441 and the second sensor 442 is not limited as long as it is a sensor capable of detecting whether an arm is present at a predetermined position in a contact or non-contact manner. In addition, the first sensor 441 and the second sensor 442 can be sensors of different detection methods.

In the arm treatment portions 42 and 42A according to the first embodiment and the second embodiment, the first sensor 441 and the second sensor 442 are disposed on the bottom wall portion 451 in the base portion 45, but the present invention is not limited to this configuration. The first sensor 441 and the second sensor 442 can be disposed on different wall portions (the bottom wall portion 451, the side wall portion 452, or the top wall portion 453) of the base portion 45. The first sensor 441 and the second sensor 442 can be disposed on any of the bottom wall portion 451, the side wall portion 452, and the top wall portion 453 of the base portion 45. At least one of the first sensor 441 and the second sensor 442 can be configured to perform sensing in a direction intersecting a direction of sandwiching the arm by the arm airbags 43. The disposition positions of the first sensor 441 and the second sensor 442 in the front-back direction are not limited. That is, the second sensor 442 only needs to be able to detect the presence or absence of the forearm, and the first sensor 441 only needs to be able to detect the tip of the hand.

In the massage device 1 according to the first embodiment, the first sensor 441 and the second sensor 442 are disposed on the same part (base portion 45), but the present invention is not limited to this configuration. The first sensor 441 and the second sensor 442 can be disposed, for example, on a part or a site other than the base portion 45 in the arm accommodating portion 41. The components other than the base portion 45 on which the first sensor 441 and the second sensor 442 are disposed can be connected to the moving mechanism and can be driven by the moving mechanism to move with the movement (sliding) of the base portion 45, or the positions in the front-back direction can be fixed with respect to the arm accommodating portion supports 40. In a case where the position of the component on which the first sensor 441 and the second sensor 442 are disposed is fixed in the front-back direction with respect to the arm accommodating portion supports 40, it is preferable that the detection portion 44 be configured to detect the position of the forearm in the arm treatment portion 42 not by a touch sensor but by a distance sensor capable of measuring the distance to the forearm, or configured to detect the position of the forearm in the arm treatment portion 42 by a plurality of photosensors disposed along the extending direction of the forearm.

In the massage devices 1 and 1A according to the first and second embodiments, the detection portion 44 is disposed in each of the right and left arm accommodating portions 41 and 41A, but the present invention is not limited to this configuration. The detection portion 44 can be disposed only in one of the arm accommodating portions 41 and 41A. In this case, the arm treatment portion 42 of the other arm accommodating portion 41 performs the same movement as the arm treatment portion 42 of the one arm accommodating portion 41 at the time of alignment of the treatment members 43 with respect to the arm. Alternatively, the other arm accommodating portion 41A performs the same movement as the one arm accommodating portion 41A at the time of alignment of the treatment members 43.

The treatment members of the arm treatment portions 42 and 42A of the massage devices 1 and 1A according to the first and second embodiments are the arm airbags 43, but the present invention is not limited to this configuration. The treatment members of each of the arm treatment portions 42 and 42A can be kneading balls or the like, or a plurality of types of treatment members can be disposed.

In the massage devices 1 and 1A according to the first embodiment and the second embodiment, the configuration for holding the forearm when stretching the arm or the upper body is the treatment members (arm airbags) 43, but the present invention is not limited to this configuration. A member or mechanism dedicated to holding the forearm can be disposed in the arm treatment portion 42.

In addition, in the massage devices 1 and 1A of the first and second embodiments, the position of the forearm is detected and the treatment members 43 are aligned with respect to the forearm after a person to be treated sits on the massage devices 1 and 1A and before the treatment is started. However, the present invention is not limited to this configuration. The massage devices 1 and 1A can be configured such that an operation portion (alignment button, switch, and the like) for aligning the treatment members 43 is provided in the remote control 7 or the like, and the detection of the forearm for aligning the treatment members 43 is started by operating the operation portion (triggered by operation of the alignment button or switch). In addition, the massage devices 1 and 1A can be configured to be switchable between a mode in which the alignment of the treatment members 43 is automatically performed and a mode in which the alignment of the treatment members 43 is not performed by an operation of the remote control 7 or the like.

The timing at which the detection portion 44 detects the forearm for alignment of the treatment members 43 is not limited. While the massage devices 1 and 1A are used (for example, the power is ON), the detection portion 44 can continuously detect the position of the forearm in the arm treatment portion 42 (can detect the position every predetermined time), and the alignment of the treatment members 43 can be performed when deviation of the forearm from the position suitable for treatment is detected. In addition, the forearm can be detected by the detection portion 44 immediately before the start of treatment or a treatment course, when the remote control 7 is operated, at a preset timing during the treatment or the treatment course, while reclining of the backrest 3, or the like. Furthermore, the detection of the forearm by the detection portion 44 can be performed at predetermined time intervals (periodically).

In addition, in the massage devices 1 and 1A according to the first and second embodiments, the detection of the forearm by the detection portion 44 and the slight movement of the treatment members 43 backward can be alternately repeated to align the treatment members 43 with the forearm. However, the present invention is not limited to this configuration.

The massage devices 1 and 1A can be configured such that, when the second sensor 442 detects the forearm and the first sensor 441 does not detect the forearm, the treatment members 43 continue to move backward until the first sensor 441 detects the forearm. That is, when the second sensor 442 detects the forearm and the control portion 6 receives a predetermined value from the first sensor 441, the control portion 6 determines that the forearm is detected. Also with this configuration, the massage devices 1 and 1A can move the treatment members 43 to positions suitable for treatment of the forearm.

In addition, in the massage devices 1 and 1A of the first and second embodiments, the alignment of the treatment members 43 with respect to the forearm is performed by moving the treatment members 43 backward while the detection portion 44 detects the forearm. However, the present invention is not limited to this configuration. The massage devices 1 and 1A can be configured such that the alignment of the treatment members 43 with respect to the forearm is performed by moving the treatment members 43 forward while the detection portion 44 detects the forearm. For example, there can be a case where the second sensor 442 does not detect the forearm while the first sensor 441 can detect the forearm. That is, it is indicated that the forearm of a person to be treated is in front of the arm treatment portion 42, and for example, the forearm is not in the range detectable by the second sensor 442. In this case, the massage devices 1 and 1A move the arm treatment portions 42 forward such that the forearm is at a suitable position.

In the massage devices 1 and 1A, the drive portions 46 and 46A can move the treatment members 43 forward in the longitudinal direction of the forearm when only the first sensor 441 detects the forearm, or can move the treatment members 43 backward in the longitudinal direction of the forearm when only the second sensor 442 detects the forearm. In the illustrated embodiment, the expression that only the first sensor 441 detects the forearm is intended to mean that the first sensor 441 detects the forearm while the second sensor 442 does not detect the forearm, and the expression that only the second sensor 442 detects the forearm is intended to mean that the second sensor 442 detects the forearm while the first sensor 441 does not detect the forearm. As a result, in the massage devices 1 and 1A, even when the treatment members 43 move due to detection of the forearm by one sensor (the first sensor or the second sensor) of the two sensors (the first sensor and the second sensor), the drive portions 46 and 46A can accurately move the treatment members 43 to positions suitable for treatment with respect to the forearm.

In addition, in the massage devices 1 and 1A, when the detection information from the first sensor 441 or the second sensor 442 changes, the drive portions 46 and 46A can stop the movement of the treatment members 43 at a predetermined timing. For example, in a case where the first sensor 441 or the second sensor 442 does not detect the forearm after the forearm is detected by the first sensor 441 and the second sensor 442, the control portion 6 determines that the forearm is not accommodated in (comes off) the arm treatment portion 42. As a result, the massage device 1 and 1A can ensure safety by stopping the drive portions 46 and 46A, for example, when the forearm comes off the arm treatment portion 42.

Further, in the massage devices 1 and 1A, the drive portions 46 and 46A can stop the movement when the detection information from the first sensor 441 and the second sensor 442 does not change. For example, in a case where both the first sensor 441 and the second sensor 442 detect the forearm and the detection information from the first sensor 441 and the second sensor 442 does not change for a predetermined time, the control portion 6 stops the movement of the arm treatment portion 42. As a result, the control portion 6 determines that the forearm is disposed at a suitable position, and stops the movement of the arm treatment portion 42, whereby unnecessary power can be saved. In addition, for example, in a case where both the first sensor 441 and the second sensor 442 do not detect the forearm for a predetermined time, the control portion 6 stops the movement of the arm treatment portion 42. Also in this case, the control portion 6 stops the movement of the arm treatment portion 42, whereby unnecessary power can be saved.

As illustrated in FIGS. 4 to 6, the arm treatment portions 42 of the massage device 1 of the above-described embodiment can include the fifth airbag 435. The fifth airbag 435 is disposed on the side wall portion 452 of the base portion 45. More specifically, the fifth airbag 435 is disposed on an inner surface 452a of the side wall portion 452 (see FIG. 4).

What is claimed is:

1. A massage device comprising:
a treatment member configured to treat a forearm of a person to be treated;
a detection portion configured to detect the forearm; and
a drive portion configured to move the treatment member in a longitudinal direction of the forearm based on detection information from the detection portion.

2. The massage device according to claim 1, further comprising
an arm treatment portion including the treatment member and the detection portion, the arm treatment portion being movable in the longitudinal direction of the forearm based on the detection information from the detection portion.

3. The massage device according to claim 2, wherein
the detection portion includes a first sensor disposed at the arm treatment portion and a second sensor disposed at the arm treatment portion and located behind the first sensor in the longitudinal direction of the forearm.

4. The massage device according to claim 1, further comprising
a backrest tiltable with respect to an installation surface on which the massage device is configured to be installed,
the treatment member being movable independently of tilting of the backrest.

5. The massage device according to claim 3, wherein
the drive portion moves the treatment member based on detection information from both the first sensor and the second sensor.

6. The massage device according to claim 3, wherein
the second sensor is configured to detect presence or absence of the forearm, and
the first sensor is configured to detect a position of a hand.

7. The massage device according to claim 3, wherein
the drive portion moves the treatment member forward in the longitudinal direction of the forearm when only the first sensor detects the forearm, or moves the treatment member backward in the longitudinal direction of the forearm when only the second sensor detects the forearm.

8. The massage device according to claim 3, wherein
the drive portion stops movement of the treatment member when both of the first sensor and the second sensor detect the forearm.

9. The massage device according to claim 3, wherein
the drive portion stops movement of the treatment member when detection information from the first sensor and detection information from the second sensor do not change.

10. The massage device according to claim 2, further comprising
a backrest tiltable with respect to an installation surface on which the massage device is configured to be installed,
the treatment member being movable independently of tilting of the backrest.

11. The massage device according to claim 5, wherein
the second sensor is configured to detect presence or absence of the forearm, and
the first sensor is configured to detect a position of a hand.

12. The massage device according to claim 5, wherein
the drive portion moves the treatment member forward in the longitudinal direction of the forearm when only the first sensor detects the forearm, or moves the treatment member backward in the longitudinal direction of the forearm when only the second sensor detects the forearm.

13. The massage device according to claim 5, wherein
the drive portion stops movement of the treatment member when both of the first sensor and the second sensor detect the forearm.

14. The massage device according to claim 5, wherein
the drive portion stops movement of the treatment member when detection information from the first sensor and detection information from the second sensor do not change.
